(19) United States
(12) Patent Application Publication
(10) Pub. No.: US 2026/0363525 A1
(43) Pub. Date: Nov. 19, 2026

(54) ASYMMETRICAL ROTATING SPRAY NOZZLE ASSEMBLY FOR FILTRATION SCREEN

(71) Applicant: Johnson Screens, Inc., New Brighton, MN (US)

(72) Inventor: Warren BERG, Dayton, MN (US)

(21) Appl. No.: 19/126,145

(22) PCT Filed: Oct. 31, 2023
(86) PCT No.: PCT/US2023/036345

§ 371 Date: Apr. 30, 2025

Related U.S. Application Data
(60) Provisional application No. 63/421,053, filed on Oct. 31, 2022.

(51) Int. Cl. A47L 15/42; B05B 13/04

(52) U.S. Cl. CPC A47L 15/428; B05B 13/0421

(57) ABSTRACT

An asymmetrical rotating spray nozzle system and related methods of controlled fluid disbursement onto a filtration or dewatering panel using an asymmetrical rotating spray nozzle assembly. The asymmetrical rotating spray nozzle system generally includes a sieve panel and an asymmetrical rotating spray nozzle assembly having a central hub, at least one arm or a plurality of arm segments, a nozzle connector at attached near an end of each of the at least one arm or plurality of arm segments and one or more fluid-dispensing nozzles on each at least one arm or plurality of arm segments such that a set of reaction forces stemming from the asymmetrical rotating spray nozzle assembly are balanced.

### PRIORITY CLAIM

The present application claims priority to U.S. Provisional Patent Application No. 63/421,053 filed Oct. 31, 2022, the entire content of which is hereby incorporated by reference.

### FIELD OF THE INVENTION

The present invention is directed to spray assemblies and spray systems for fluid disbursement onto filtration screens. More specifically, the present invention is directed to asymmetrical rotating spray nozzle assemblies and dewatering or filtration systems utilizing asymmetrical rotating spray nozzle assemblies to spray fluids to clean and rinse filtration or dewatering screens,

### BACKGROUND

Many applications require systems configured to spray fluid outwards from a plurality of nozzles towards a surface that must be washed or cleaned. Examples include dishwashers, slurry screens located within food processing plants, metal and mineral processing, and municipal and industrial waste processing. Generally, the washing process occurs using an automated system configured to automatically spray fluid without the need for human intervention. Alternatively, the washing process occurs using one or more manual operators physically operating a fluid-spraying system such as, for example, a hose that may be manually deployed as needed.

For automated spray systems, several nozzles are typically positioned symmetrically around an axis of rotation as shown in the conventional spray system of FIGS. 1A-IC. In this configuration, each nozzle is paired with at least one other nozzle such that they have the same circular rotational path around an axis of rotation of the system. Other nozzle pairs are placed in different circular rotational paths with each pair being placed in a path unique to that pair. This creates several circular paths by which the nozzle pairs rotate around and subsequently spray fluid outwards onto a surface. Additionally, the equal distribution of nozzle pairs balances the reaction forces presented when the spray system is in operation.

One primary disadvantage of using such a symmetrical configuration of nozzles is that there can be gaps between each circular rotational path that do not receive any fluid if, for example, the surface to be sprayed is close to the spray system or the nozzles of the spray system have narrow spray patterns. This typically results in several unwashed areas on the surface being sprayed. This then requires a manual operator to spray the remaining areas using a separate fluid spraying system. Furthermore, a symmetrical configuration typically uses more nozzles than are actually required to wash a particular surface thus resulting in a significant waste of fluid, The introduction of excess fluid can be especially disadvantageous in dewatering applications. As such, there exists a need for a spraying system that corrects the inefficiencies typically found in conventional symmetrical spraying systems.

### SUMMARY

The present disclosure provides solutions to, among other things, the issue of excess nozzle use, and consequently, excess liquid application, typically found in conventional symmetrical spray systems utilized. In particular, embodiments of the present disclosure provide the same level of spray coverage as conventional systems but with fewer nozzles, or better spray coverage with the same number of nozzles.

In embodiments of the present invention, an asymmetrical rotating spray nozzle system can be positioned proximate a filtration screen, such as, for example, a dewatering of sieve panel. The asymmetrical rotating spray nozzle assembly can have a central hub defining a central rotation axis and at least one arm or at least two arm segments arranged symmetrically or asymmetrically around an axis of rotation of the asymmetrical rotating spray nozzle assembly, each one of the at least one arm or two arm segments having the same or different length and being couplable to a lateral surface of the central hub, a nozzle connector fixedly couplable to a distal end of each one of the at least one arm or at least two arm segments, at least one fluid-dispensing nozzle fixedly couplable to each nozzle connector and each one of the at least one arm or at least two arm segments, the at least one fluid-dispensing nozzle oriented at an angle relative to an arm axis defined by at least one arm or at least two arm segments through the central hub and positioned at a unique distance away from the axis of rotation, and, optionally, a counterweight mounted to one or more arm such that the reaction forces stemming from the asymmetrical rotating spray nozzle assembly are balanced. In some embodiments, the at least one arm or at least two arm segments can comprise a nonlinear arm or arm segments.

In embodiments, the central hub of the asymmetrical rotating spray nozzle assembly can have an elongated cylindrical geometric configuration. In embodiments, each one of the at least one arm is cylindrically-shaped and elongated, for example, formed of conventional piping or tubing though in certain embodiments, alternative configurations, for example, having a square or other geometrical cross-section is contemplated. In embodiments, each one of the at least one arm is spaced equidistantly around the lateral surface of the central bub. In embodiments, each one of the at least one arm is spaced non-equidistantly around the lateral surface of the central bub. In embodiments, each one of the at least one arm is configured to have the same fluid flow rate. In embodiments, each one of the at least one arm is configured to have a different fluid flow rate.

In embodiments, the asymmetrical rotating spray nozzle system further comprises one or more fluid-dispensing nozzles removably couplable to each one of the at least one arm, wherein the one or more fluid-dispensing nozzles removably couplable to each one of the at least one arm are positioned at a combination of different symmetrical and asymmetrical locations within the asymmetrical rotating spray nozzle assembly. In embodiments, each one of the at least one arm is removably couplable to the lateral surface of the central hub. In embodiments, the asymmetrical rotating spray nozzle assembly is provided as a single manufactured assembly such that each one of the at least one arm is fixedly coupled to the lateral surface of the central hub.

In embodiments, a method of controlled fluid disbursement onto a sieve panel comprises the steps of supplying an asymmetrical rotating spray nozzle assembly configured to dispense fluid through at least one fluid-dispensing nozzle, positioning the asymmetrical rotating spray nozzle assembly proximate the sieve panel, directing a fluid from the asymmetrical rotating spray nozzle assembly outwards and onto the sieve panel, and removing the fluid from the sieve panel via a set of slots defined within the sieve panel,

In embodiments, the method of controlled fluid disbursement onto a sieve panel may further comprise one or more of the steps of mounting a counterweight to at least one arm such that a set of reaction forces stemming from the asymmetrical rotating spray nozzle assembly are balanced, attaching to a central hub at least one arm having a nozzle connector designed such that a fluid-dispensing nozzle may be connected to the nozzle connector, connecting a fluid-dispensing nozzle to each nozzle connector such that each fluid-dispensing nozzle is oriented in a direction facing the sieve panel, determining an optimal position of at least one fluid-dispensing nozzle via a mathematical formula, and positioning each one of the at least one fluid-dispensing nozzles at a combination of different symmetrical and asymmetrical locations.

The above summary is not intended to describe each illustrated embodiment or every implementation of the subject matter hereof. The figures and the detailed description that follow more particularly exemplify various embodiments.

### BRIEF DESCRIPTION OF THE DRAWINGS

Subject matter hereof may be more completely understood in consideration of the following detailed description of various embodiments in connection with the accompanying figures, in which:

FIG. IA is a perspective view of a symmetrical rotating spray nozzle assembly found in the prior art.

FIG. 1B is a front view of the symmetrical rotating spray nozzle assembly shown in FIG. 1A.

FIG. 1C is a side view of the symmetrical rotating spray nozzle assembly shown in FIG. 1A.

FIG. 2A is a perspective view of an asymmetrical rotating spray nozzle assembly in accordance with an embodiment of the present invention.

FIG. 2B is a front view of the asymmetrical rotating spray nozzle assembly shown in FIG. 2A.

FIG. 2C is a side view of the rotating spray nozzle assembly shown in FIG. 2A.

FIG. 3 is a perspective view of an asymmetrical rotating spray nozzle system in accordance with an embodiment of the present invention.

FIG. 4A is a perspective view of an asymmetrical rotating spray nozzle assembly in accordance with an embodiment of the present invention.

FIG. 4B is a front view of the asymmetrical rotating spray nozzle assembly shown in FIG. 4A.

FIG. 4C is a side view of the asymmetrical rotating spray nozzle assembly shown in FIG. 4A.

FIG. 5 is a perspective view of an asymmetrical rotating spray nozzle system in accordance with an embodiment of the present invention.

FIG. 6A is a perspective view of an asymmetrical rotating spray nozzle assembly in accordance with an embodiment of the present invention.

FIG. 6B is a front view of the asymmetrical rotating spray nozzle assembly shown in FIG. 6A.

FIG. 6C is a side view of the asymmetrical rotating spray nozzle assembly shown in FIG. 6A.

FIG. 7 is a perspective view of an asymmetrical rotating spray nozzle system in accordance with an embodiment of the present invention.

FIG. 8 is a side view of an asymmetrical rotation spray nozzle system in accordance with an embodiment of the present invention.

FIG. 9 is a perspective view of an symmetrical rotating spray nozzle system in accordance with an embodiment of the present invention.

FIG. 10 is a method of using an asymmetrical rotating spray nozzle assembly in accordance with an embodiment of the present invention.

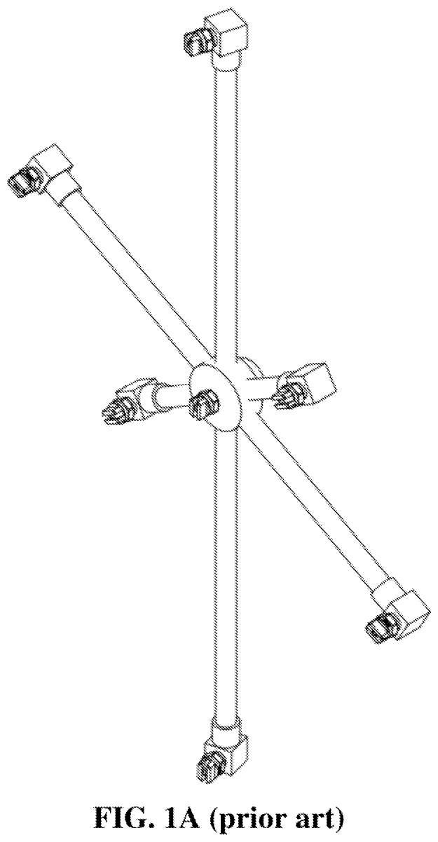

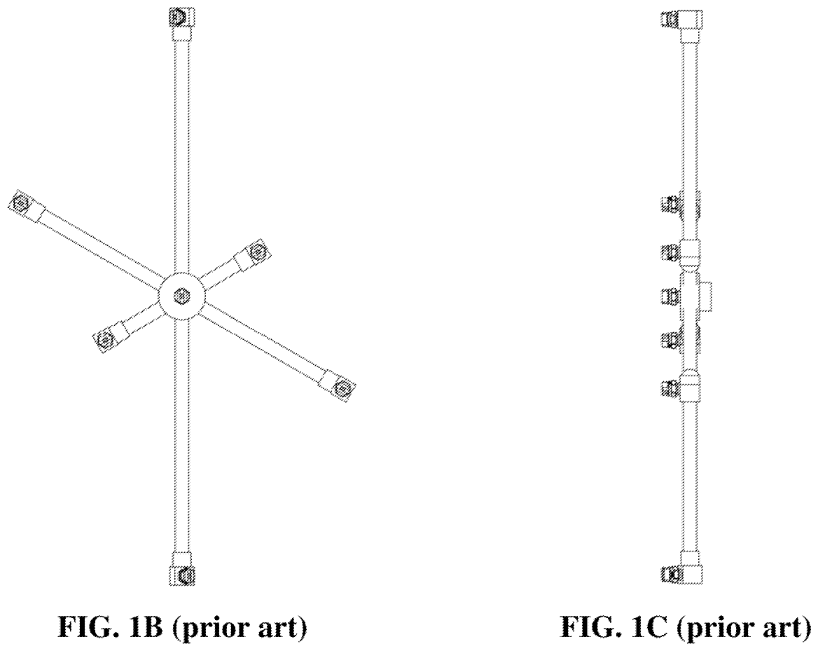

While various embodiments are amenable to various modifications and alternative forms, specifics thereof have been shown by way of example in the drawings and will be described in detail. It should be understood, however, that the intention is not to limit the claimed inventions to the particular embodiments described. On the contrary, the intention is to cover all modifications, equivalents, and alternatives falling within the spirit and scope of the subject matter as defined by the claims.

### DETAILED DESCRIPTION OF THE DRAWINGS

Referring generally to FIGS. IA, IB, and IC, a conventional symmetrical rotating spray nozzle assembly of the prior art generally comprises a plurality of arm combinations each consisting of two arms having equal lengths, each arm being connected to a central hub defining a central rotation axis of the symmetrical rotating spray nozzle assembly. Each arm generally including a connector piece and a nozzle attached to a distal end of the arm with each nozzle being oriented such that each fluid-dispensing end of the nozzles all face the same direction and are optionally angled to cause rotation,

The critical aspect of this conventional symmetrical rotating spray nozzle assembly is that it consists of various pairs of arms having equal or non-equal lengths rather than individual arms having different lengths. This creates several circular paths around the central rotation axis by which the arm pairs rotate around and subsequently spray fluid outwards onto a surface. The primary disadvantage of such a configuration is that there are gaps between each circular rotational path that do not receive any fluid thus leaving untouched areas on the surface being sprayed (assuming either that the sprayed surface is close to the spray system or the nozzles of the spray system have narrow spray patterns). In addition, each arm of the pair of arms includes a nozzle assembly that is similarly spaced such that each circular path is covered by two nozzle assemblies resulting in excess fluid being sprayed onto the same circular path.

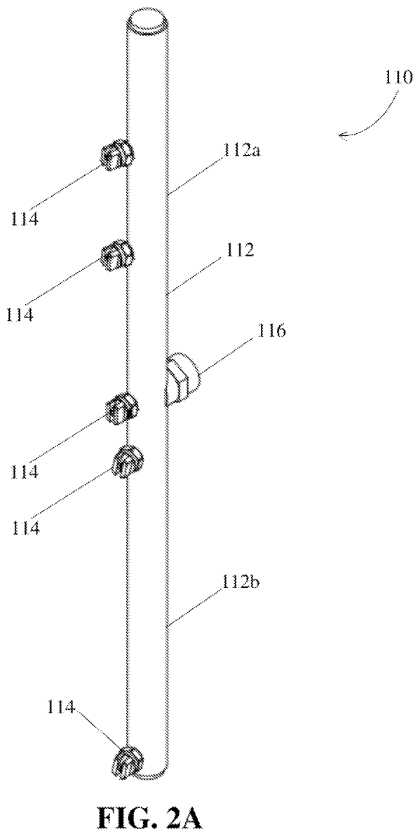

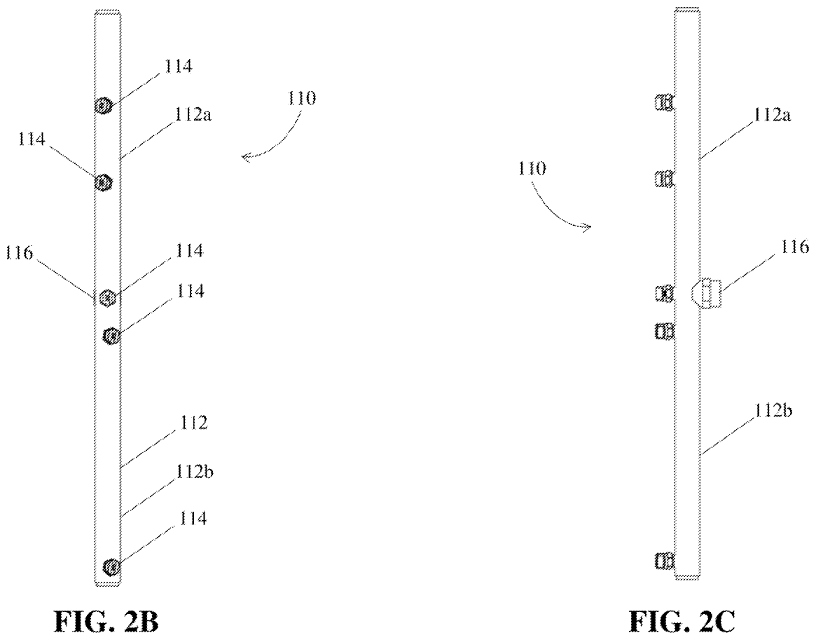

Referring generally to FIGS. 2A, 2B, and 2C, an asymmetrical rotating spray nozzle assembly 110 according to an embodiment of the present invention generally comprises an arm 112, a plurality of fluid-dispensing nozzles 114, and a central hub 116. Asymmetrical rotating spray nozzle assembly 110 can provide the same spraying coverage as the conventional symmetrical rotating spray nozzle assembly with fewer nozzles, or provide better spraying coverage with the same number of nozzles as the symmetrical rotating spray nozzle assembly while being designed to be inherently balanced without the need for any counterweights on arm 112.

Arm 112 can have an elongated cylindrical geometric configuration, for example, a length of conventional tubing or pipe, though other geometric configurations are contemplated. A total length of the arm 112 is variable depending on the particular spraying application in which asymmetrical rotating spray nozzle assembly 110 is being used, though lengths including, but not limited to, 12 inches to 48 inches are contemplated. Likewise, a cross-sectional diameter of arm 112 is variable depending on the particular spraying application, though cross-sectional diameters including, but not limited to, 0.5 inches to 3 inches are contemplated. Arm 112 essentially comprises two arm segments 112a, 1126 with each arm segment being defined on opposed sides of the central hub 116. Arm 112 is generally manufactured of fluid compatible materials such as, for example, metals such as stainless steel or aluminum, polymeric materials such PVC, ceramics and other composite materials.

A plurality of fluid-dispensing nozzles 114 are removably couplable to arm 112 and are generally oriented in a direction facing a filtration or dewatering panel 150. In one embodiment, each of the plurality of fluid-dispensing nozzles 114 can be oriented to spray in the same direction or plane. In an alternative embodiment, the fluid-dispensing nozzles 114 can be oriented in different directions (i.e., located in different planes). The plurality of fluid-dispensing nozzles 114 can be positioned along a common centerline extending from a top edge to a bottom edge of arm 112 or can be arranged at different radial locations along arm 112 to accommodate different spray patterns. Positioning some or all of the fluid-dispensing nozzles 114 at a spray angle relative to the common centerline allows arm 112 to rotate while in operation. Preferably, fluid-dispensing nozzles 114 comprise spray nozzles having a fan spray pattern defining a spray angle between 20° and 60°, and more preferably between 30° and 40°. Alternatively, fluid-dispensing nozzles 114 can comprise spray nozzles defining other spray patterns, such as, for example cones, jets and combinations thereof.

Central hub 116 is configured for mounting asymmetrical rotating spray nozzle assembly to a surface when spraying occurs. Central hub 116 generally comprises a sealed bearing assembly (not depicted) allowing the arm 112 to rotate about the central hub 116. In addition, central hub 116 can include a fluid connection that allows the asymmetrical rotating spray nozzle assembly 110 to be fluidly connected to an available fluid source that will ultimately be sprayed from the fluid-dispensing nozzles 114. The connection system 116 can be directly connected to a central arm aperture (not shown) to establish a fluid connection between the fluid source and an interior of the arm 112 for supplying fluid-dispensing nozzles 114. As illustrated, the fluid spraying from fluid-dispensing nozzles 114 provides the motive force to drive rotation of the arm 112 about the central hub 116. In some alternative embodiments, a motor can be attached to the central hub 116 to rotate the arm 112 at a desired rate.

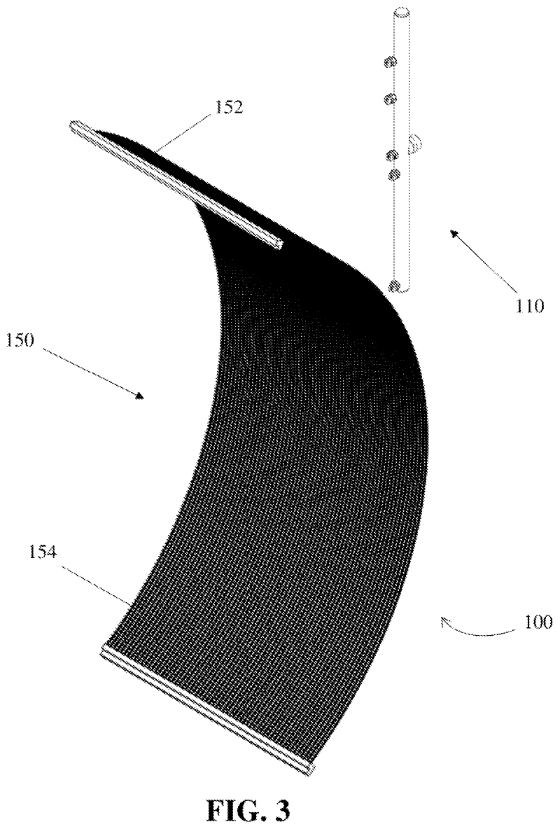

Referring generally to FIG. 3, a filtration or dewatering system 100 can comprise a filtration or dewatering panel 150 and an asymmetrical rotting spray nozzle assembly 110 positioned to face a rear surface 152 of filtration or dewatering panel 150. Generally, asymmetrical rotating spray nozzle assembly 110 can be positioned approximately 2 inches away from filtration or dewatering panel 150, though other distances are contemplated based on the needs and size restrictions of a particular spraying application. While illustrated as showing the asymmetrical rotating spray nozzle assembly 110 spraying towards the rear surface of the filtration or dewatering panel 150, it will be understood that in certain applications, it may be advantageous to reverse the location of the asymmetrical rotating spray nozzle assembly 110 so as to spray a front surface 154 of the filtration or dewatering panel 150.

The filtration or dewatering panel 150 generally includes a plurality of screening elements that are mounted to an underlying support structure. The filtration or dewatering panel 150 generally defines an upper screening surface that extends between an upper end and a lower end. The upper screening surface generally defines a number of openings or “slots” over which a slurry is passed and dewatered. The upper end and the lower end can comprise mounting members such as, for example, angled bars or flanges for otherwise coupling and retaining the filtration or dewatering panel 150 during use. In some embodiments, the screen surface can comprise a screen surface conventionally referred to as a shaped-wire or Vee-wire surface. In operation, a slurry will generally be introduced onto the filtration or dewatering panel 150 at the upper end and will flow by gravity toward the lower end. As the slurry flows down the filtration or dewatering panel 150 and over the upper screening surface, liquid and entrained particles smaller than the openings/slots will flow through the upper screening surface, while particles larger than the openings/slots travel along the upper screening surface such that they are essentially concentrated at the lower end of the sieve panel for subsequent processing. Generally, the asymmetrical rotating spray nozzle assembly 110 can be configured to spray on demand, generally, every 4 to 8 hours for several seconds or even minutes at a time depending upon the application and loading to dislodge, remove and rinse any particulates that have accumulated on the filtration or dewatering panel 150, As mentioned previously, some embodiments of the present invention the asymmetrical rotating spray nozzle assembly 110 can be positioned so as to spray the front surface 154 of filtration or dewatering panel 150 instead of the rear surface.

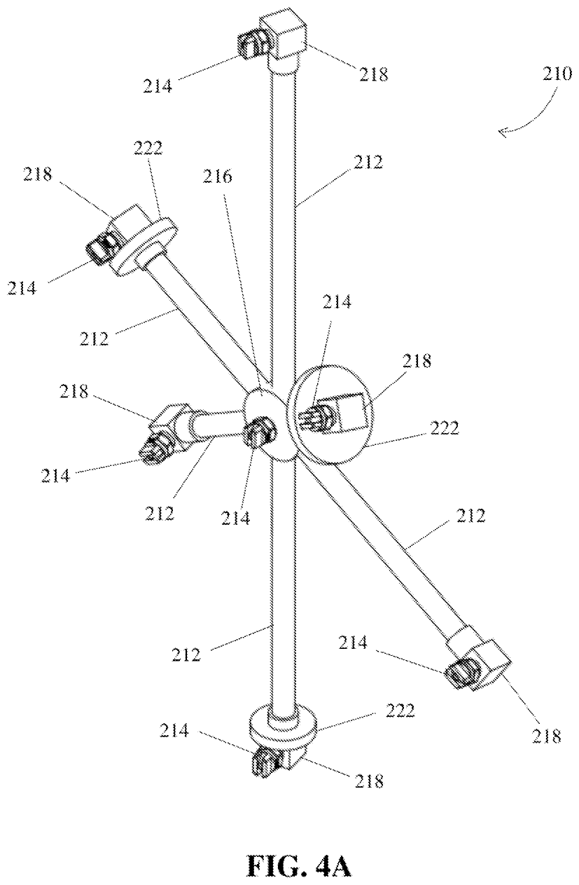

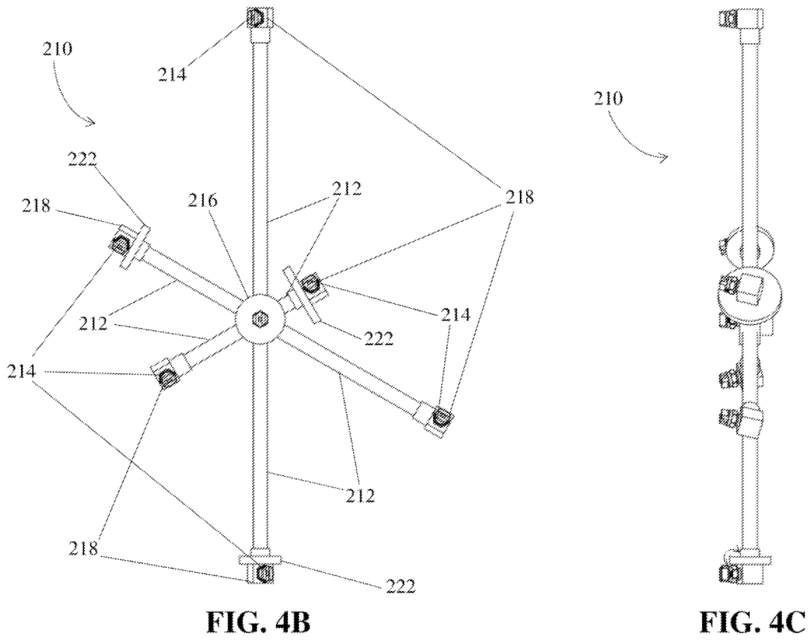

Referring to embodiments illustrated in FIGS. 4A, 4B, and 4C, asymmetrical rotating spray nozzle assembly 210 generally comprises a central hub 216, a plurality of arm segments 212, a plurality of nozzle connectors 218, one or more fluid-dispensing nozzles 214, and optionally, a counterweight 222 mounted to at least one arm segment 212. Central hub 216 generally defines a central rotation axis of the asymmetrical rotating spray nozzle assembly 210. Advantages of asymmetrical rotating spray nozzle assembly 210 over conventional assemblies include being powered without a motor due to the forces created during spraying (embodiments that include a separate motor are contemplated) and providing either the same spraying coverage with fewer nozzles, or better spraying coverage with the same number of nozzles.

Central hub 216 generally has a main segment typically having an elongated cylindrical geometric configuration with a top surface, a bottom surface, and a lateral surface between the top and bottom surfaces, and a connection segment extruding from the bottom surface of the main segment for mounting to a swivel assembly (not depicted). The connection segment generally has a cylindrical configuration similar in design to the main segment, as shown most prominently in FIG. 4C, but may vary in size depending on design requirements, Other geometric configurations for central hub 216 such as rectangular, triangular, and spherical are also contemplated. Central hub 216 is generally manufactured from a metallic material such as stainless steel or aluminum, though other materials such as polymers, ceramics, and composites are contemplated.

The plurality of arm segments 212 generally have a hollow, elongated cylindrical geometric configuration such as conventional pipe or tubing, though other geometric configurations are contemplated. Each arm segment 212 of the plurality of arm segments 212 is couplable to the lateral surface of the central hob 216, typically either removably such that the number of arm segments 212 can be varied, or fixed such that the number of arm segments 212 is unchangeable for a particular asymmetrical rotating spray nozzle assembly 210. The plurality of arm segments 212 can comprise any number of arm segments 212 such as, for example, two, three, or six arms 212. The plurality of arm segments 212 can be spaced equidistantly around the lateral surface of the central hub 216, or variably spaced at locations suitable for a particular spraying application. The plurality of arm segments 212 is generally manufactured from a metallic material such as stainless steel or aluminum, though other materials such as polymers, ceramics, and composites are contemplated. In some embodiments, arm segments 212 can be positioned on opposed sides of the central hub 216 such that an opposed pair of the arm segments 212 functionally resemble and perform in a manner similar to arm 112 as illustrated and previously described.

A nozzle connector 218 is fixedly or removably couplable to a distal end of each arm segment 212. Nozzle connector 218 functions as an intermediate connection point between arm segments 212 and each fluid-dispensing nozzle 214 such that fluid can flow without interruption through each arm segment 212 and out through each fluid-dispensing nozzle 214. Nozzle connector 218 generally comprises a cubic structure connected with an elongated cylindrically-shaped segment so as to create a single manufactured piece, the cylindrically-shaped segment having an aperture extending through the hollow, middle portion of each arm segment 212 and sized sufficiently to allow an outer surface of each arm segment 212 to be coincident with an inner surface of the aperture. Nozzle connector 218 is generally manufactured from a metallic material such as stainless steel or aluminum, though other materials such as polymers, ceramics, and composites are contemplated.

One or more fluid-dispensing nozzles 214 can be fixedly couplable to each nozzle connector 218 and generally oriented in a direction facing a filtration or dewatering panel 250 or other targeted surface, though other orientations are contemplated. In embodiments, each of the one or more fluid-dispensing nozzles 214 can be oriented in the same direction or plane. Alternatively, the fluid-dispensing nozzles 214 can be oriented in different directions (i.e., located in different planes) to accommodate spraying multiple filtration or dewatering panels 250 or to accommodate variation in the filtration or dewatering panel 250. The one or more fluid-dispensing nozzles 214 can be positioned along a common centerline extending from a top edge to a bottom edge of each arm segment 212 or can be placed at different radial locations along each arm segment 212 to accommodate different spray patterns or different targeted areas.

The one or more fluid-dispensing nozzles 214 can comprise fan nozzles defining a fan spray pattern with a spray angle between 20° and 60°, and preferably between 30° and 40°. Alternatively, fluid-dispensing nozzles 214 can comprise spray nozzles defining other spray patterns, such as, for example cones, jets and combinations thereof.

One or more fluid-dispensing nozzles 214 can be fixedly coupled to at least one of the plurality of arm segments 212 and positioned at a combination of different symmetrical and asymmetrical locations suitable for a particular spraying application. In embodiment, a fluid-dispensing nozzle 214 is removably couplable to either the top or bottom surfaces of central bub 216 in a direction facing or opposing the one or more fluid dispensing nozzles 214 couplable to each nozzle connector 218.

In embodiments, a counterweight 222 can be mounted to one or more arm segments 212 such that the reaction forces stemming from the asymmetrical rotating spray nozzle assembly 210 are balanced. Counterweight 222 generally has an elongated cylindrical geometric configuration with an aperture extending through a middle portion and sized sufficiently to allow an outer surface of arm segment 212 to be coincident with an inner surface of the aperture. Other geometric configurations of counterweight 222 suitable for mounting to one or more arm segment 212 are also contemplated and can be more practical depending on the particular setting in which asymmetrical rotating spray nozzle assembly 210 is being used. Counterweight 222 can vary in mass depending on the particular spraying application and the structural needs of the corresponding asymmetrical rotating spray nozzle assembly 210. For example, a plurality of counterweights 222 each having a different mass can be used to balance the reaction forces stemming from asymmetrical rotating spray nozzle assembly 210. Counterweight 222 is generally manufactured from a metallic material such as stainless steel or aluminum, though other materials such as polymers, ceramics, and composites are contemplated. In embodiments, counterweight 222 and nozzle connector 218 may be manufactured as a single piece for simplicity.

In operation and with reference to filtration or dewatering panel 250, fluid flows from a fluid source into central hub 216 and through each arm segment 212 and nozzle connector 218 of the asymmetrical rotating spray nozzle assembly 210. The fluid flow rate may be the same or may be different for each arm 212 segment. The fluid then flows outwards from the one or more fluid-dispensing nozzles 214 and is sprayed onto the filtration or dewatering panel 250. Depending upon the application, the asymmetrical rotating spray nozzle assembly 210 can be operated continuously, though in many applications the asymmetrical rotating spray nozzle assembly 210 will be operated intermittently, for example, for several seconds or minutes every 4 to 8 hours so as to avoid introducing excess fluid into a process.

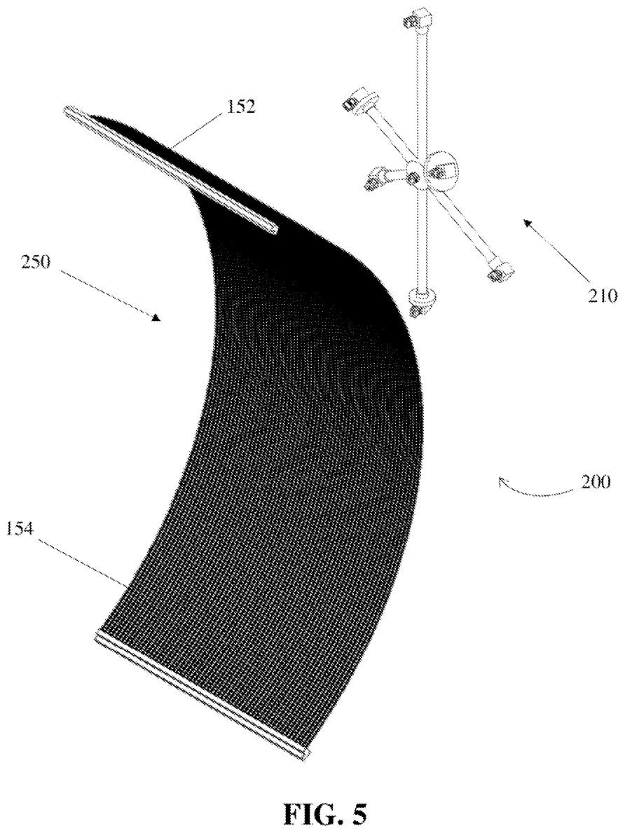

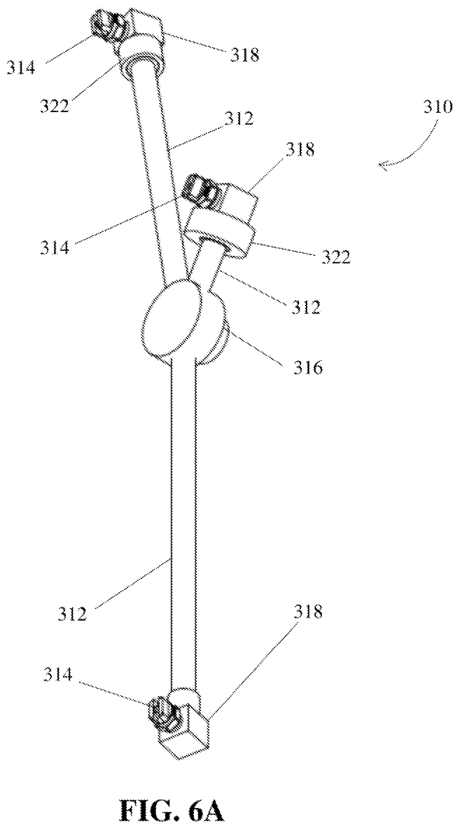

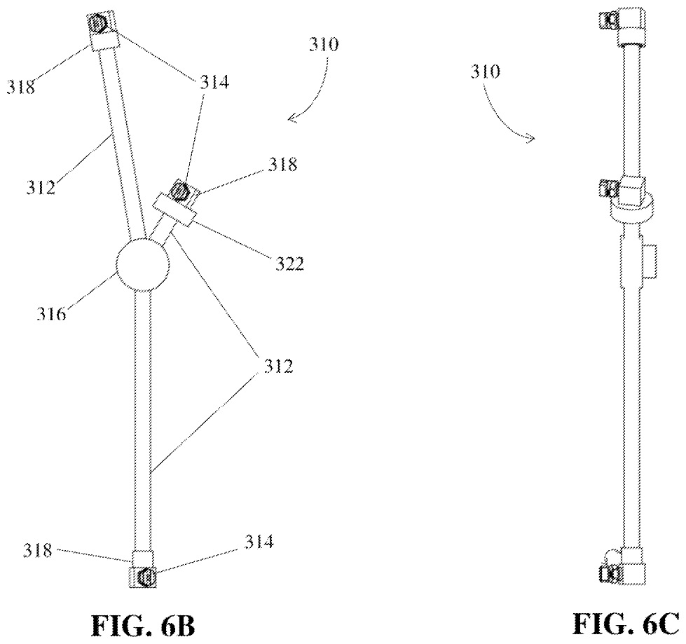

Referring now to FIG. 5, an asymmetrical rotating spray nozzle assembly system 200 can comprise a filtration or dewatering panel 250 and an asymmetrical rotating spray nozzle assembly 210 having, for example, six arm segments 212 and positioned to face a rear surface 152 of filtration or dewatering panel 250, as shown and described herein. Operation of asymmetrical rotating spray nozzle assembly 210 with filtration or dewatering panel 250 can be continuous, though in many applications operation will be intermittent, for example, for several seconds or minutes every 4 to 8 hours so as to avoid introducing excess fluid into a process, In an alternative embodiment, asymmetrical rotating spray nozzle assembly 210 can be positioned to face a front surface 154 of filtration or dewatering panel 250 instead of the rear surface 152.

Referring now to FIGS, 6A, 6B, and 6C, an asymmetrical rotating spray nozzle assembly 310 is shown according to another embodiment of the invention. Asymmetrical rotating spray nozzle assembly 310 is structurally similar to asymmetrical rotating spray nozzle assembly 210 apart from having three instead of six arm segments 312. For the sake of simplicity, like-numbered elements of asymmetrical rotating spray nozzle assembly 310 are assumed to be identical to the corresponding elements of asymmetrical rotating spray nozzle assembly 210 (e.g., arm segment 312 is equivalent to arm segment 212, nozzle connector 318 is equivalent to nozzle connector 218, and so forth). Similar to embodiments described previously, asymmetrical rotating spray nozzle assembly 310 can utilize the motive force provide by spraying from fluid-dispensing nozzles 314 to rotate the arm segments 312 about the central hub 316, though in some embodiments, a motor can be utilized to provide desired rates of rotation for the asymmetrical rotating spray nozzle assembly 310.

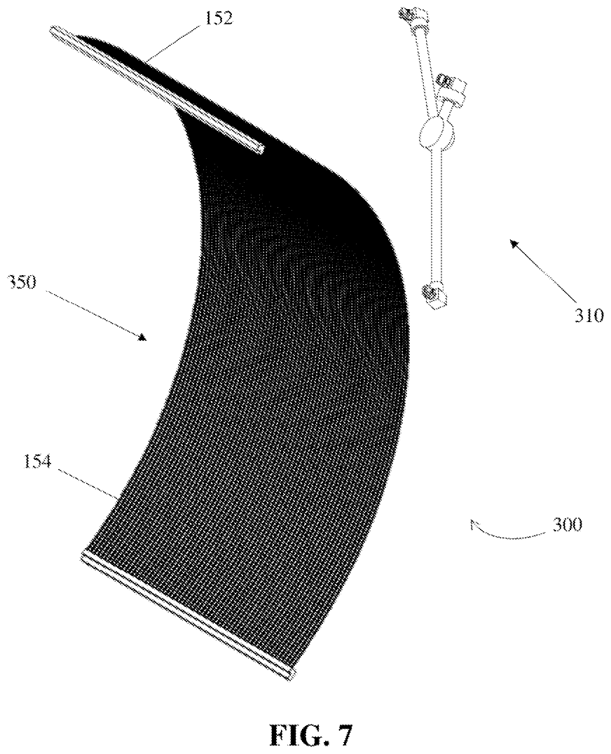

Referring now to FIG. 7, an asymmetrical rotating spray nozzle assembly system 300 can comprise a filtration or dewatering panel 350 and an asymmetrical rotating spray nozzle assembly 310 having three arm segments 312 and positioned to face a rear surface 152 of filtration or dewatering panel 350, as shown and described herein. Operation of asymmetrical rotating spray nozzle assembly 310 with filtration or dewatering panel 350 can be continuous. though in many applications operation can be intermittent for several seconds or minutes every 4 to 8 hours to avoid introducing excess fluid to a process. In an alternative embodiment, asymmetrical rotating spray nozzle assembly 310 can be positioned to face the front surface 154 of filtration or dewatering panel 350 instead of the rear surface 152.

In operation, the fluid dispensing nozzles 114, 214, 314 utilized with the asymmetrical rotating spray nozzle assemblies 110, 210, 310 can operate with a spray pressure of 1,000 to 2,000 psi. In certain applications, it can be beneficial to operate at lower spray pressures, for example, in continuous spray applications or in applications wherein the spray application is for a longer period of time, Le. longer than several minutes at a time.

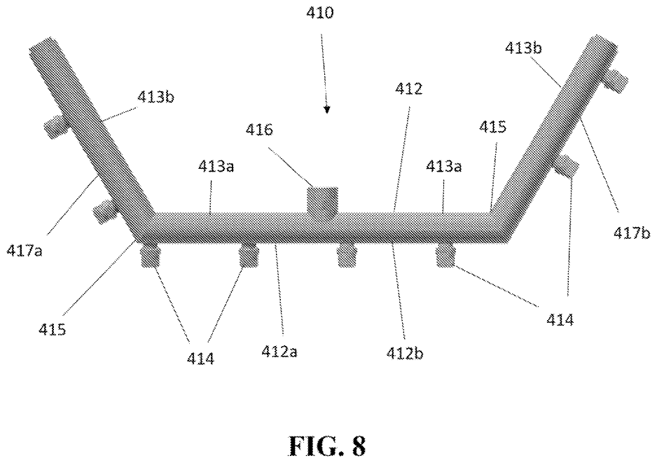

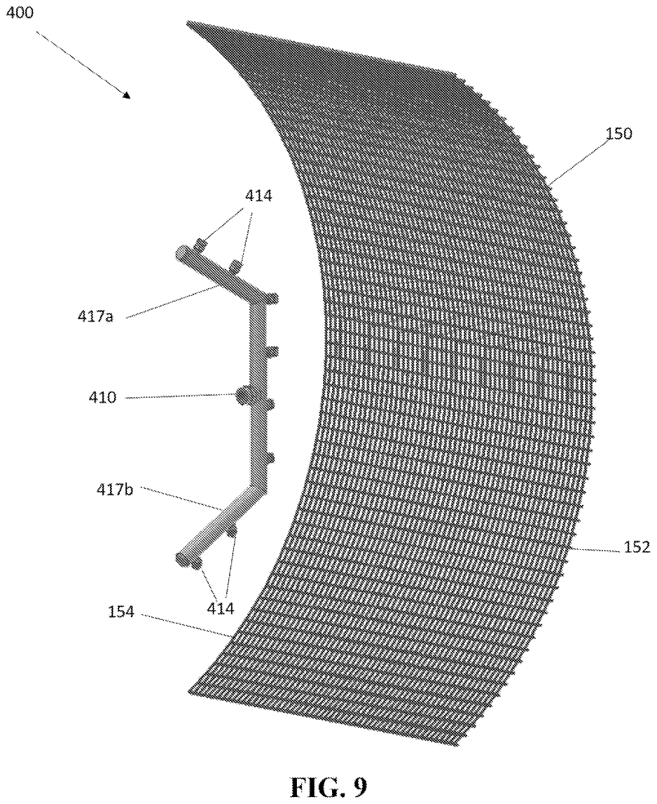

As shown in FIG. 8, an asymmetrical rotating spray nozzle assembly 410 is shown according to another embodiment of the invention. Asymmetrical rotating spray nozzle assembly 410 can comprise an arm 412, a plurality of fluid-dispensing nozzles 414 and a central hub 416. Arm 412 can be defined by a pair of arm segments 412a. 412b located on opposed sides of the central hub 416. Each arm segment 412a, 412b is further defined by an interior segment 413a and an exterior segment 413b, wherein interior and exterior refer to proximity relative to the central hub 416. Interior segment 413a and exterior segment 413b are fluidly coupled at an elbow 415 such that each arm segment 412a, 412b defines a nonlinear arm segment 417a, 417b. Alternatively, the nonlinear arm segments 417a, 417b can comprise a curved arrangement. As seen in FIG. 8, a plurality of fluid dispensing nozzles 414 are spaced at different lengths form the central hub 416. By positioning the fluid dispensing nozzles 414 at appropriate distances, the asymmetrical arrangement provides for enhanced spray coverage while inherently balancing the asymmetrical rotating spray nozzle assembly 410. Alternatively, one or more counterweights can be attached at the ends of one or both of the arm segments 412a, 412b to balance the asymmetrical rotating spray assembly 410.

With reference to FIG. 9, the nonlinear arm segments 417a, 417b of the asymmetrical rotation spray nozzle assembly 410 can find enhanced utility as part of a filtration or dewatering system 400 positioned to spray against an interior curved portion of a filtration or dewatering panel 150, As shown, the asymmetrical rotation spray nozzle assembly 410 can be mounted relative to the filtration or dewatering panel 150 so as to spray on the front surface 154. Alternatively, the asymmetrical rotation spray nozzle assembly 410 can be mounted relative to the filtration or dewatering panel 150 so as to spray on the rear surface 152, The number of fluid dispensing nozzles 414 on the nonlinear arm segments 417a, 417b can be specifically selected and spaced based on the application.

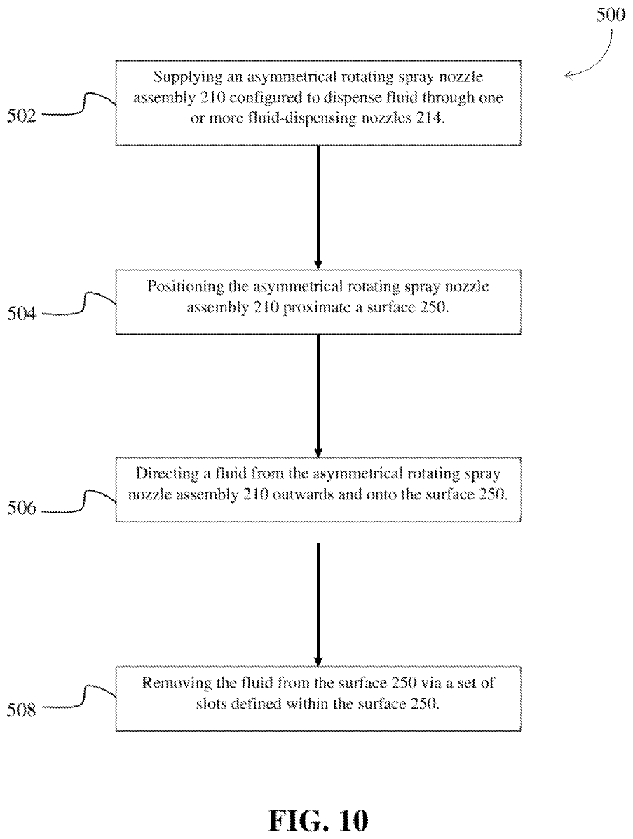

Referring now to FIG. 10, a method 500 of controlled fluid disbursement is generally described with respect to filtration or dewatering panel 250. In step 502, an asymmetrical rotating spray nozzle assembly 210 is configured to dispense fluid through one or more fluid-dispensing nozzles 214. In step 504, the asymmetrical rotating spray nozzle assembly 210 is positioned proximate the filtration or dewatering panel 250. In step 504, the asymmetrical rotating spray nozzle assembly 210 can be positioned proximate a rear surface or alternatively, a front surface of the filtration or dewatering panel 250. In step 506, a fluid is directed from the asymmetrical rotating spray nozzle assembly 210 and sprayed outwards onto the filtration or dewatering panel 250. Step 506 can be continuous or intermittent based on the process. In step 508, the fluid is removed from the filtration or dewatering panel 250 via a set of slots defined within the sieve panel 250.

Various embodiments of systems, devices, and methods have been described herein. These embodiments are given only by way of example and are not intended to limit the scope of the claimed inventions. It should be appreciated, moreover, that the various features of the embodiments that have been described may be combined in various ways to produce numerous additional embodiments. Moreover, while various materials, dimensions, shapes, configurations and locations, etc. have been described for use with disclosed embodiments, others besides those disclosed may be utilized without exceeding the scope of the claimed inventions.

Persons of ordinary skill in the relevant arts will recognize that the subject matter hereof may comprise fewer features than illustrated in any individual embodiment described above, The embodiments described herein are not meant to be an exhaustive presentation of the ways in which the various features of the subject matter hereof may be combined. Accordingly, the embodiments are not mutually exclusive combinations of features; rather, the various embodiments can comprise a combination of different individual features selected from different individual embodiments, as understood by persons of ordinary skill in the art. Moreover, elements described with respect to one embodiment can be implemented in other embodiments even when not described in such embodiments unless otherwise noted.

Although a dependent claim may refer in the claims to a specific combination with one or more other claims, other embodiments can also include a combination of the dependent claim with the subject matter of each other dependent claim or a combination of one or more features with other dependent or independent claims, Such combinations are proposed herein unless it is stated that a specific combination is not intended.

Any incorporation by reference of documents above is limited such that no subject matter is incorporated that is contrary to the explicit disclosure herein. Any incorporation by reference of documents above is further limited such that no claims included in the documents are incorporated by reference herein. Any incorporation by reference of documents above is yet further limited such that any definitions provided in the documents are not incorporated by reference herein unless expressly included herein.

For purposes of interpreting the claims, it is expressly intended that the provisions of 35 U.S.C. § 112(0) are not to be invoked unless the specific terms “means for” or “step for” are recited in a claim.

1. An asymmetrical rotating spray nozzle system, comprising:
a filtration or dewatering panel; and
an asymmetrical rotating spray nozzle assembly positioned proximate the filtration or dewatering panel, the asymmetrical rotating spray nozzle assembly having:
a central hub defining a central rotation axis of the asymmetrical rotating spray nozzle assembly;
at least two arm segments arranged around and coupled to the central hub, ;
at least one fluid-dispensing nozzle fluidly coupled along each of the at least two arm segments, wherein the distance between the fluid-dispensing nozzles and the central rotation axis on at least one of the arms is unique.

2. The asymmetrical rotating spray nozzle system of claim 1, further comprising at least three arm segments, wherein the distance between the fluid-dispensing nozzles and the central rotation axis is different for at least one of the at least three arm segments.

3. The asymmetrical rotating spray nozzle system of claim 1, further comprising at least six arm segments, wherein the distance between the fluid-dispensing nozzles and the central rotation axis is different for at least one of the at least six arm segments.

4. The asymmetrical rotating spray nozzle system of claim 1, wherein at least one of the two arm segments includes two or more fluid-dispensing nozzles fluidly coupled along the arm segments.

5. The asymmetrical rotating spray nozzle system of claim 1, wherein the fluid dispensing nozzles have a spray pattern selected from a fan, a cone, a jet and combinations thereof.

6. The asymmetrical rotating spray nozzle system of claim 1, wherein the fluid dispensing nozzles have a fan spray pattern with a spray angle of between 20° and 60°.

7. The asymmetrical rotating spray nozzle system of claim 6, wherein the spray angle is between 30° and 40°.

8. The asymmetrical rotating spray nozzle system of claim 1, wherein the fluid dispensing nozzles have a spray pressure of between 1,000-2,000 psi.

9. The asymmetrical rotating spray nozzle system of claim 1, wherein the asymmetrical rotating spray nozzle assembly is operated continuously.

10. The asymmetrical rotating spray nozzle system of claim 1, wherein the asymmetrical rotating spray nozzle assembly is operated intermittently.

11. The asymmetrical rotating spray nozzle system of claim 10, wherein the asymmetrical rotating spray nozzle assembly is operated every 4 to 8 hours.

12. The asymmetrical rotating spray nozzle system of claim 1, wherein the central hub includes a sealed bearing assembly.

13. The asymmetrical rotation spray nozzle assembly of claim 1, wherein the central hub is connected to a central aperture on a length of tubing or pipe defining the at least two arm segments.

14. The asymmetrical rotating spray nozzle system of claim 1, wherein the asymmetrical rotating spray nozzle assembly is spaced apart from the filtration or dewatering panel by approximately 2 inches.

15. The asymmetrical rotating spray nozzle system of claim 1, wherein the central hub includes a fluid-dispensing nozzle.

16. The asymmetrical rotating spray nozzle system of claim 1, wherein the asymmetrical rotating spray nozzle assembly is positioned proximate a rear surface of the filtration or dewatering panel.

17. The asymmetrical rotating spray nozzle system of claim 1, wherein the asymmetrical rotating spray nozzle assembly is positioned proximate a front surface of the filtration or dewatering panel.

18. The asymmetrical rotating spray nozzle system of claim 1, wherein the at least two arm segments define at least two nonlinear arm segments.

19. A method of controlled fluid disbursement onto a filtration or dewatering panel, the method comprising the steps of:
supplying an asymmetrical rotating spray nozzle assembly configured to dispense fluid through at least two fluid-dispensing nozzles, wherein at least one of the at least two fluid-dispensing nozzles is located at a unique distance relative to a central rotation axis;
positioning the asymmetrical rotating spray nozzle assembly proximate the filtration or dewatering panel; and
directing a fluid from the asymmetrical rotating spray nozzle assembly outwards and onto the filtration or dewatering panel.

20. The method of claim 19, wherein the step of directing the fluid is continuous.

21. The method of claim 19, wherein the step of directing the fluid is intermittent.

22. The method of claim 21, wherein the step of directing the fluid occurs every 4 to 8 hours.

23. The method of claim 19, wherein the step of directing the fluid further comprises:
spraying fluid from each fluid-dispensing nozzle in a spray pattern selected from a fan pattern, a cone pattern, a jet pattern or combinations thereof.

24. The method of claim 19, wherein the step of directing the fluid further comprises:
spraying fluid from each fluid-dispensing nozzle in a fan pattern having a spray angle of between 20° and 60°.

25. The method of claim 24, wherein the spray angle is between 30° and 40°.

26. The method of claim 19, wherein the step of directing the fluid further comprises:
spraying fluid from each fluid-dispensing nozzle at a spray pressure of between 1,000-2,000 psi.

27. The method of claim 19, where the step of positioning the asymmetrical rotating spray nozzle assembly proximate the filtration or dewatering panel further comprises:
positioning the asymmetrical rotating spray nozzle assembly proximate a front surface of the filtration or dewatering panel.

28. The method of claim 19, where the step of positioning the asymmetrical rotating spray nozzle assembly proximate the filtration or dewatering panel further comprises:
positioning the asymmetrical rotating spray nozzle assembly proximate a rear surface of the filtration or dewatering panel.

29. The method of claim 19, where the step of positioning the asymmetrical rotating spray nozzle assembly proximate the filtration or dewatering panel further comprises:
positioning the asymmetrical rotating spray nozzle assembly approximately 2 inches from the filtration or dewatering panel.

30. An asymmetrical rotating spray nozzle assembly, comprising:
a central hub defining a central rotation axis of the asymmetrical rotating spray nozzle assembly;
at least two arm segments fluidly coupled to and arranged around the central hub;
and
at least one fluid-dispensing nozzle fluidly coupled along each of the at least two arm segments, wherein the distance between the fluid-dispensing nozzles and the central rotation axis is unique for at least one of the at least two arms.

31. The asymmetrical rotating spray nozzle assembly of claim 30, further comprising at least three arm segments, wherein the distance between the fluid-dispensing nozzles and the central rotation axis is different for at least one of the at least three arm segments.

32. The asymmetrical rotating spray nozzle assembly of claim 30, further comprising at least six arm segments, wherein the distance between the fluid-dispensing nozzles and the central rotation axis is different for at least one of the at least six arm segments.

33. The asymmetrical rotating spray nozzle assembly of claim 30, wherein at least one of the at least two arm segments includes two or more fluid-dispensing nozzles fluidly coupled along the arm segment.

34. The asymmetrical rotating spray nozzle assembly of claim 30, wherein the fluid dispensing nozzles have a spray pattern selected from a fan, a cone, a jet and combinations thereof.

35. The asymmetrical rotating spray nozzle assembly of claim 30, wherein the fluid dispensing nozzles have a fan spray pattern with a spray angle of between 20° and 60°.

36. The asymmetrical rotating spray nozzle assembly of claim 35, wherein the spray angle is between 30° and 40°.

37. The asymmetrical rotating spray nozzle assembly of claim 30, wherein the fluid dispensing nozzles have a spray pressure of between 1,000-2,000 psi.

38. The asymmetrical rotating spray nozzle assembly of claim 30, wherein the central hub includes a sealed bearing assembly.

39. The asymmetrical rotating spray nozzle assembly of claim 30, wherein the central hub includes a fluid-dispensing nozzle.

40. The asymmetrical rotating spray nozzle assembly of claim 30, wherein the at least two arm segments define at least two nonlinear arm segments.
